(19) United States
(12) Patent Application Publication
(10) Pub. No.: US 2010/0134616 A1
(43) Pub. Date: Jun. 3, 2010

(54) COLOR MASK FOR AN IMAGE SENSOR OF A VEHICLE CAMERA

(76) Inventors: Ulrich Seger, Leonberg-Warmbronn (DE); Lothar Bergen, Gerlingen (DE); Steffen Fritz, Wurmberg (DE)

Correspondence Address: KENYON & KENYON LLP, ONE BROADWAY, NEW YORK, NY, 10004, US

(21) Appl. No.: 12/452,935

(22) PCT Filed: Jul. 7, 2008
(86) PCT No.: PCT/EP2008/058742

§ 371 Date: Jan. 29, 2010

(51) Int. Cl. H04N 9/68; H04N 7/18

(52) U.S. Cl. 348/135; 348/238; 348/E09.053; 348/E07.085

(57) ABSTRACT

A color mask for an image sensor of a vehicle camera has a matrix arrangement made up of first filter pixels and second filter pixels. In every horizontal row and/or every vertical column, first filter pixels and second filter pixels are situated, the first filter pixels and the second filter pixels having different transmission behaviors. The second filter pixels have a more comprehensive transmission behavior, e.g., completely transparent to optical light. The first filter pixels are preferably red.

### BACKGROUND OF THE INVENTION

1. Field of the Invention

The present invention relates to a color mask for an image sensor of a vehicle camera.

2. Description of Related Art

For switching between low beam and high beam of a vehicle, automatic switching systems are known in which a vehicle camera detects whether other vehicles or road users are present in a relevant range ahead of the vehicle and the headlights are automatically switched between high beam and low beam as a function of this detection. The cameras generally have sensors including a color mask which enable a color differentiation, in particular a red/white differentiation, in order to detect the generally red taillights and the generally white low beams and high beams of other vehicles and to differentiate between them. For example, it should be possible to distinguish a low red light from a white reflection on another object, e.g., a traffic sign.

One of the greatest difficulties in implementing the red/white differentiation is the size of the light sources, since the light sources are generally only displayed on one sensor pixel. Due to the color mask, one is thus reliant on a moving light source for implementation, which illuminates different pixels with different colors based on the movement.

Standard Bayer pattern masks are generally used as color masks in which every second filter pixel of the color mask is green, these green filter pixels being situated distributed alternatingly in a chessboard pattern across the matrix arrangement of the filter pixels. Blue and red filter pixels are situated in the other matrix areas, with rows having green and blue pixels and rows having red and green pixels alternating. This standard Bayer pattern mask enables a complete color differentiation, i.e., interpretation into the colors red, blue, and green. However, the reduction of the high-sensitivity resolution by the factor 2 as opposed to that of a monochrome image sensor is disadvantageous. Moreover, reduced filter masks are known in which some color pixels of this standard Bayer pattern are omitted and thus transparent pixels remain in their place, thereby increasing the high-sensitivity resolution.

Japanese patent document JP 2004304706 A shows a color filter having green, white, red, and blue color filter segments, of which the white segments, used for a luminescence signal, occupy every other matrix area in a chessboard pattern and the color segments occupy the remaining half of the matrix areas. Rows having white and green segments and rows having white, red, and blue segments alternate, so that two blue segments and two red segments are situated diagonally opposite on the corners of each green segment. Moreover, an interpolation method for analyzing the image signals, which are recorded using such a color mask, is described.

### BRIEF SUMMARY OF THE INVENTION

The present invention is based on the idea of providing a color mask or filter mask having only two different filter pixels which are offset to each other in the rows and/or columns of the matrix arrangement.

In a specific example embodiment, the first filter pixels have a red transmission characteristic and the second filter pixels have a broader transmission characteristic including the red spectral range and additional spectral ranges. In this case, the second filter pixels may be completely transparent, in particular in the optical range.

According to the present invention, a filter pixel or filter segment is referred to as a red filter pixel which is transparent to light in the red wavelength range and essentially non-transparent to other wavelength ranges. A filter pixel or filter segment is referred to as a transparent filter pixel which is transparent to light in a wider wavelength range and thus essentially appears transparent or white in the optical range; it therefore allows a luminescence signal in which the total luminosity is measured. When applying the color mask, the mask for the transparent filter pixels may thus be omitted, so that a process step is not necessary here and complete transparency is achieved.

By providing only transparent and red filter pixels according to the present invention, the filter pixels to be used for detecting a low beam or a high beam or a taillight may have a high-sensitivity resolution as opposed to an image sensor without a color mask having a resolution reduction of only approximately 1.5, for example.

According to the present invention, this is based on the findings that pitching motions in particular, i.e., pivoting motions (rotations) about the transverse axis, as well as yawing motions, i.e., pivoting motions (rotations) about the vertical axis, occur in a vehicle. Pitching motions occur in particular during braking and accelerating processes and due to road bumps; yawing motions occur in particular due to greater or also smaller steering actions. In particular, the relative motion between the vehicle having the camera according to the present invention and the object to be detected is relevant here, so that a relative yawing motion may also occur during straight-line driving with respect to an object situated offset to the lane of the vehicle, e.g., a vehicle traveling in the oncoming lane.

In this case, pitching motions correspond to a migration of the detected light source in the vertical direction on the matrix arrangement, i.e., along the columns. A yawing motion corresponds to the migration of the dot along a horizontal row of the matrix arrangement. An optical system, situated in the camera in front of the sensor, possibly generates an inversion of the directions, i.e., right and left as well as up and down; however, this is not relevant for the principle of the present invention to detect horizontal yawing motions and vertical pitching motions.

As a typical case, the occurrence of pure pitching motions is detected in the vehicle. For this purpose, a matrix arrangement is created in which red filter pixels are situated in each column, e.g., as each fourth pixel in each column, consecutive columns being preferably offset to one another. Purely transparent rows may similarly also result here, since they are irrelevant for detecting a pitching motion. A pitching motion may thus be relatively reliably detected, even in the event of a relatively small number of red color pixels.

According to a further embodiment, pure yawing motions may be detected, for which the red filter pixels are situated in all rows, preferably again offset to one another, i.e., in consecutive rows at spots offset to one another.

For detecting yawing motions as well as pitching motions, an offset of the red filter pixels by rows and columns may take place, so that, for example, a chessboard-pattern of red and transparent pixels may result in which transparent and red pixels, alternating in the columns direction and the rows direction, are provided; however, a resolution loss by a factor of 2 may occur as opposed to an image sensor without a color mask. A lesser number of red pixels may correspondingly be provided in this specific embodiment.

According to the present invention, other embodiments than red/transparent may basically also be selected. In particular, a narrower transmission spectrum, i.e., a colored filter pixel such as also blue, yellow or green or mixed colors, may be combined with a broader transmission spectrum, transparent in particular. Furthermore, two spectral ranges, which overlap only partially or not at all, may also be selected.

### BRIEF DESCRIPTION OF SEVERAL VIEWS OF THE DRAWING

FIG. 1 shows a top view onto a road scene of a vehicle having a camera.

FIG. 2 shows a camera system in the vehicle having an image sensor and a color mask in a side view and a lateral section.

FIG. 3 shows a color mask according to a first example embodiment for detecting pitching motions in particular.

FIG. 4 shows a color mask according to a second example embodiment for detecting yawing motions in particular.

FIG. 5 shows a color mask according to a third example embodiment for detecting different motions.

### DETAILED DESCRIPTION OF THE INVENTION

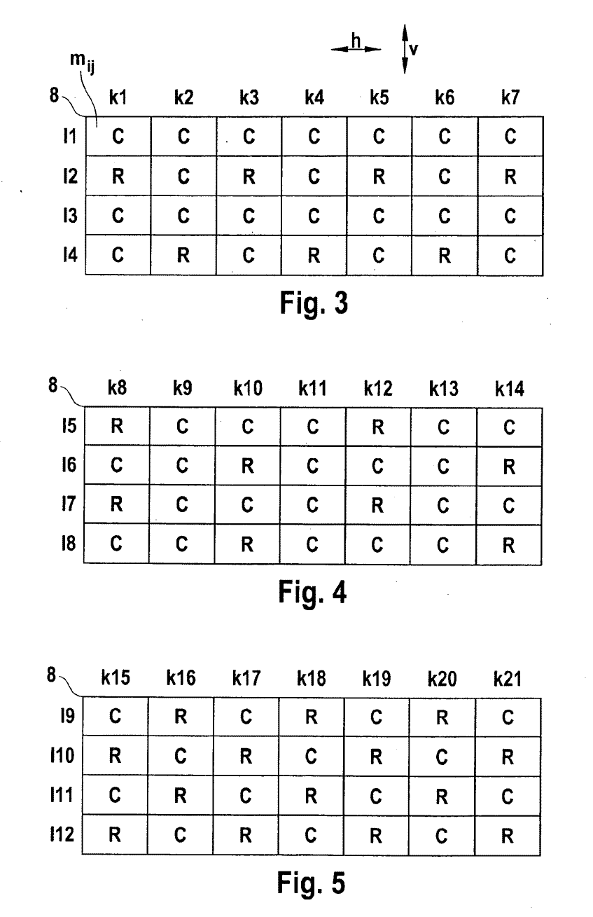

A vehicle 1 having a camera 2 travels on a lane 3. In detection range 4 of camera 2, different objects O1, O2, O3 situated on and outside lane 3 are detected. According to FIG. 2, camera 2 is installed behind a window 5 of vehicle 1, in particular windshield 5 and has, in addition to optics 6 (not shown in detail), an image sensor 7 having a matrix arrangement of sensor pixels and a color mask (filter mask) 8, attached to image sensor 7, of which different specific embodiments are shown in FIGS. 3 through 5. Image sensor 7 gathers the optical light incident through color mask 8 and outputs image signals S1 to control and analyzer device 9 which is then able to carry out an analysis in appropriate high-sensitivity resolution, whereupon appropriate warning messages may be issued if needed or also direct interventions in the vehicle management system may take place.

Color mask 8 has a matrix arrangement of filter pixels mᵢⱼ with i=1, 2, . . . and j=1, 2, . . . , a 4×7 matrix being shown in FIGS. 3 through 5 for the sake of simplifying the illustration. Filter pixels mᵢⱼ filter the incident light and let light in a predefined wavelength range pass. According to the shown specific embodiments, filter pixels mᵢⱼ are either completely (or essentially completely) transparent for optical light; such filter pixels mᵢⱼ are indicated as C (clear) and are thus transparent or “white,” or, as red filter pixels, let essentially only red light pass and are indicated by R.

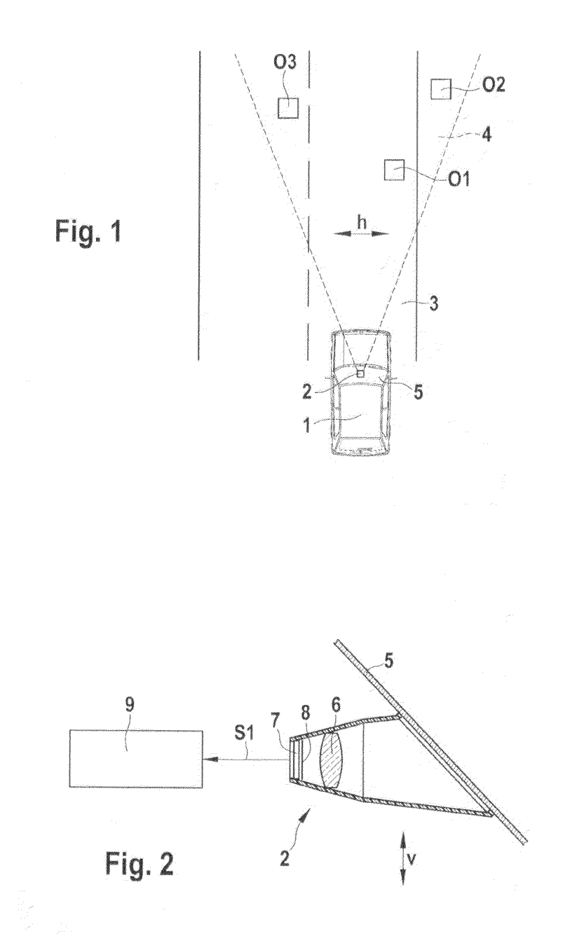

Each filter pixel mᵢⱼ is placed, e.g., glued, directly in front of an image sensor pixel; the distance between image sensor 7 and color mask 8 in FIG. 2 is only shown for the sake of clarity. Matrix arrangement mᵢⱼ has horizontal rows l1, l2, l3, l4 and vertical columns k1, k2, k3, . . . . The horizontal direction of rows li thus corresponds to horizontal direction h in FIG. 1; the direction of vertical columns kⱼ corresponds to vertical direction v in FIG. 2.

According to the present invention, small light sources of objects O1, O2, O3 are also taken into account which are displayed on only one image sensor pixel. Due to the motion of vehicle 1 and/or objects O1, O2, O3, the respective light source sweeps over multiple pixels on the image sensor matrix and the attached color matrix mᵢⱼ. During a pitching motion of vehicle 1, i.e., a rotation about its transverse axis, camera 2 is panned in vertical direction v, so that object O1, O2, O3, recognized as a light source, moves in the direction of columns kj; during a yawing motion, i.e., a rotation of the vehicle about its vertical axis (yaw axis), i.e., parallel to lane 3 in horizontal direction h in FIG. 1, the light source signal of objects O1, O2, O3 thus moves in the horizontal direction, i.e., along a row li.

The specific embodiment in FIG. 3 shows a color matrix arrangement in which three of four pixels are transparent and each fourth pixel is red, red filter pixels R being situated in all columns kj. Purely transparent rows 11, 13 preferably alternate here whose filter pixels M1j and m3j are for all j=1, 2, 3 . . . C, and rows l2, l4, lying in between, in which red and transparent filter pixels alternate, i.e., m21=m23=m25=m27=R and m22=m24=m 26=C, for example.

The specific embodiment in FIG. 3 is particularly suitable for covering pure pitching motions of vehicle 1, i.e., a motion of camera 2 in the vertical direction or columns direction. Since vehicles typically experience pitching motions, in particular during accelerating and braking, as well as due to road bumps, the respective object O1, O2, O3 will sweep over multiple sequential filter pixels mij and thus also over one red filter pixel R even when displayed only on one pixel in the respective column kj.

In contrast to a reduced Bayer pattern color matrix, which has purely transparent columns, it is possible, at the same high-sensitivity resolution using a surprisingly simple measure—namely the offset placement of red filter pixels R—to increase substantially in typical pitching motions the reliability of distinguishing a red light from a white reflection. In contrast to a full RGB Bayer pattern, only a resolution reduction by a factor of approximately 1.5 occurs.

In the specific embodiment in FIG. 4, red filter pixels R are provided in all rows ki. Purely transparent columns k9, k11, k13 preferably alternate here with combined, i.e., transparent/red columns k8, k10, k12, k14 in which a red filter pixel R and a transparent filter pixel C are situated in an alternating manner. Here again, three out of four pixels are transparent and each fourth pixel is red, i.e., at the same physical high-sensitivity resolution as in FIG. 3.

During a yawing motion in which the camera pans in horizontal direction h, also a small light source is detected by transparent as well as red pixels.

FIG. 5 shows a combined specific embodiment in which red filter pixels R and transparent pixels C alternate in the columns and the rows direction, so that a chessboard pattern of R and C results. This pattern may cover pure yawing and pitching motions, as well as combined motions; however, a resolution lost by the factor 2 occurs compared to a sensor 7 without a color mask.

Control and analyzer device 9 may thus compare the intensities of image signals S1 with transparent filter pixels (luminescence signal) and red filter pixels and ascertain from the result whether the image of a light source moving across the matrix arrangement has white or red light.

1-12. (canceled)

13. A color mask for an image sensor of a vehicle camera, comprising:
a matrix arrangement of a plurality of first filter pixels and a plurality of second filter pixels, wherein the first filter pixels and the second filter pixels have different transmission behaviors for optical light, and wherein the matrix arrangement includes horizontal rows and vertical columns, and wherein at least one of: (a) each row of the matrix arrangement includes at least one first filter pixel and at least one second filter pixel; and (b) each column of the matrix arrangement includes at least one first filter pixel and at least one second filter pixel.

14. The color mask as recited in claim 13, wherein the matrix arrangement includes only the first filter pixels and the second filter pixels.

15. The color mask as recited in claim 13, wherein the wavelength range transmitted by the second filter pixels includes the wavelength range transmitted by the first filter pixels.

16. The color mask as recited in claim 15, wherein the second filter pixels are essentially completely transparent to optical light.

17. The color mask as recited in claim 15, wherein the first filter pixels are red filter pixels.

18. The color mask as recited in claim 15, wherein the first filter pixels are situated offset relative to one another in at least one of (a) sequential rows and (b) sequential columns.

19. The color mask as recited in claim 18, wherein the matrix arrangement has alternating rows of a first row type and a second row type, the first row type solely including second filter pixels and the second row type including both the first and second filter pixels, and wherein two nearest rows of second row type include the first filter pixels in different columns.

20. The color mask as recited in claim 18, wherein the matrix arrangement has alternating columns of a first column type and a second column type, the first column type including both the first and second filter pixels, and the second column type solely including second filter pixels, and wherein two nearest columns of first column type include the first filter pixels in different rows.

21. The color mask as recited in claim 18, wherein the matrix arrangement includes alternating first pixels and second pixels in each column and in each row.

22. The color mask as recited in claim 21, wherein the first filter pixels and the second filter pixels form a chessboard pattern having first diagonals of first filter pixels and second diagonals of second filter pixels.

23. A camera for a vehicle, comprising:
an image sensor having a matrix arrangement of sensor pixels for receiving optical light and outputting image signals; and
a color mask situated in front of the image sensor, wherein the color mask includes:
a matrix arrangement of a plurality of first filter pixels and a plurality of second filter pixels, wherein the first filter pixels and the second filter pixels have different transmission behaviors for optical light, and wherein the matrix arrangement includes horizontal rows and vertical columns, and wherein at least one of: (a) each row of the matrix arrangement includes at least one first filter pixel and at least one second filter pixel; and (b) each column of the matrix arrangement includes at least one first filter pixel and at least one second filter pixel;
wherein each filter pixel is situated directly in front of a sensor pixel.

24. A vehicle image-sensing system, comprising:
a camera for a vehicle, the camera including:
an image sensor having a matrix arrangement of sensor pixels for receiving optical light and outputting image signals;
a color mask situated in front of the image sensor, wherein the color mask includes:
a matrix arrangement of a plurality of first filter pixels and a plurality of second filter pixels, wherein the first filter pixels and the second filter pixels have different transmission behaviors for optical light, and wherein the matrix arrangement includes horizontal rows and vertical columns, and wherein at least one of: (a) each row of the matrix arrangement includes at least one first filter pixel and at least one second filter pixel; and (b) each column of the matrix arrangement includes at least one first filter pixel and at least one second filter pixel;
wherein each filter pixel is situated directly in front of a sensor pixel; and
at least one control-and-analyzer device receiving image signals from the camera and ascertaining from a time curve of the image signals whether objects emitting a red tail-light or a white head-light are situated in a detection range of the camera.
